(19) United States
(12) Patent Application Publication
(10) Pub. No.: US 2025/0305881 A1
(43) Pub. Date: Oct. 2, 2025

(54) NON-TRANSITORY COMPUTER READABLE MEDIUM, OPTICAL SPECTRUM MEASUREMENT METHOD, AND OPTICAL SPECTRUM ANALYZER

(71) Applicants: Yokogawa Electric Corporation, Tokyo (JP); Yokogawa Test & Measurement Corporation, Tokyo (JP); National University Corporation YOKOHAMA National University, Yokohama-shi (JP); KANAGAWA INSTITUTE OF INDUSTRIAL SCIENCE AND TECHNOLOGY, Ebina-shi (JP)

(72) Inventors: Kenta Yamamoto, Tokyo (JP); Manabu Kojima, Tokyo (JP); Ikufumi Katayama, Yokohama-shi (JP); Ryo Tamaki, Ebina-shi (JP)

(73) Assignees: Yokogawa Electric Corporation, Tokyo (JP); Yokogawa Test & Measurement Corporation, Tokyo (JP); National University Corporation YOKOHAMA National University, Yokohama-shi (JP); KANAGAWA INSTITUTE OF INDUSTRIAL SCIENCE AND TECHNOLOGY, Ebina-shi (JP)

(21) Appl. No.: 19/057,262

(22) Filed: Feb. 19, 2025

(30) Foreign Application Priority Data
Mar. 28, 2024 (JP) 2024-054806

(51) Int. Cl. G01J 3/32; G01J 3/10

(52) U.S. Cl. CPC G01J 3/32; G01J 3/10

(57) ABSTRACT

A non-transitory computer readable medium stores an optical spectrum measurement program to measure, in a single sweep, optical spectra of multiple light rays to be measured. The optical spectrum measurement program is configured to cause a processor to acquire a measurement result of the intensity of a light ray to be measured that is selected one-by-one from among the multiple light rays to be measured, and generate an optical spectrum of each light ray to be measured by associating the light ray to be measured that has been selected during measurement with the acquired measurement result.

### CROSS-REFERENCE TO RELATED APPLICATION

This application claims priority to Japanese Patent Application No. 2024-54806, filed on Mar. 28, 2024, the entire contents of which are incorporated herein by reference.

### TECHNICAL FIELD

The present disclosure relates to a non-transitory computer readable medium, an optical spectrum measurement method, and an optical spectrum analyzer.

### BACKGROUND

Spectroscopes with rotatable gratings are known, as described in Patent Literature (PTL) 1.

### CITATION LIST

### Patent Literature

PTL 1: JP 5339027 B2

### SUMMARY

A non-transitory computer readable medium according to some embodiments stores an optical spectrum measurement program. The optical spectrum measurement program is a program to measure, in a single sweep, optical spectra of multiple light rays to be measured. The optical spectrum measurement program is configured to cause a processor to execute operations including:
acquiring a measurement result of the intensity of a light ray to be measured that is selected one-by-one from among the multiple light rays to be measured; and
generating an optical spectrum of each light ray to be measured by associating the light ray to be measured that has been selected during measurement with the acquired measurement result.

An optical spectrum measurement method according to some embodiments is a method of measuring, in a single sweep, optical spectra of multiple light rays to be measured. The optical spectrum measurement method includes:
acquiring a measurement result of the intensity of a light ray to be measured that is selected one-by-one from among the multiple light rays to be measured; and
generating an optical spectrum of each light ray to be measured by associating the light ray to be measured that has been selected during measurement with the acquired measurement result.

An optical spectrum analyzer according to some embodiments is configured to generate, in a single sweep, optical spectra of multiple light rays to be measured. The optical spectrum analyzer includes:
at least one measurement unit configured to measure the intensity of a light ray to be measured that is selected one-by-one from among the multiple light rays to be measured; and
a controller configured to generate an optical spectrum of each light ray to be measured, by associating the light ray to be measured that has been selected during measurement of the light intensity by the measurement unit with a measurement result of the light intensity by the measurement unit.

### BRIEF DESCRIPTION OF THE DRAWINGS

In the accompanying drawings:

FIG. 1 is a block diagram illustrating a configuration of an apparatus according to a comparative example;

FIG. 2 is a graph illustrating measurement waveforms obtained by a method according to the comparative example;

FIG. 3 is a block diagram illustrating an example configuration of an optical spectrum analyzer according to the present disclosure;

FIG. 4 is a flowchart illustrating an example procedure of an optical spectrum measurement method according to the present disclosure;

FIG. 5 is a timing chart of a sweep in the optical spectrum measurement method in FIG. 4;

FIG. 6 is an example of measurement waveforms of first and second light rays to be measured, generated based on measurement results of light intensity at each wavelength obtained by performing the sweep in FIG. 5;

FIG. 7A is an example of measurement waveforms obtained by performing the optical spectrum measurement method;

FIG. 7B is a differential waveform between the measurement waveforms of the first and second light rays to be measured in FIG. 7A;

FIG. 8A is an example of measurement waveforms obtained by performing the method according to the comparison example;

FIG. 8B is a differential waveform between the measurement waveforms of the first and second light rays to be measured in FIG. 8A;

FIG. 9 is a block diagram illustrating an example configuration of an optical spectrum analyzer that switches, in response to input of a trigger signal, a light ray to be measured;

FIG. 10 is a flowchart illustrating an example procedure of an optical spectrum measurement method including a process of switching, in response to the input of the trigger signal, the light ray to be measured;

FIG. 11 is a timing chart of a sweep in the optical spectrum measurement method in FIG. 10;

FIG. 12 is a block diagram illustrating an example configuration of an optical spectrum analyzer with two measurement units; and

FIG. 13 is a block diagram illustrating an example configuration of an optical spectrum analyzer with an optical switch connected externally.

### DETAILED DESCRIPTION

When measuring an optical spectrum, optical spectrum analyzers rotate a grating at an angle corresponding to each wavelength from a start wavelength to an end wavelength of a measurement wavelength range, and measure the optical spectrum, which is light intensity at respective wavelengths. Some optical spectrum analyzers measure optical spectra of multiple light rays to be measured. Such optical spectrum analyzers measure an optical spectrum of a single light ray to be measured, and then measure an optical spectrum of the next light ray to be measured by switching to the next light ray to be measured. In this case, there is a time difference between the measurements of the multiple light rays to be measured. Due to the time difference between the measurements of the light rays to be measured, measurement conditions for each light ray to be measured may fluctuate. The fluctuations in the measurement conditions for each light ray to be measured may cause improper comparison between the measurement results of the respective light rays to be measured. In order to allow the measurement results of the respective light rays to be measured to be compared correctly, it is required to reduce a difference in the measurement conditions for the respective light rays to be measured.

A non-temporary computer readable medium, an optical spectrum measurement method, and an optical spectrum analyzer according to the present disclosure reduces a difference in measurement conditions for respective multiple light rays to be measured.

(1) A non-transitory computer readable medium according to some embodiments stores an optical spectrum measurement program. The optical spectrum measurement program is a program to measure, in a single sweep, optical spectra of multiple light rays to be measured. The optical spectrum measurement program is configured to cause a processor to execute operations, the operations including:
acquiring a measurement result of the intensity of a light ray to be measured that is selected one-by-one from among the multiple light rays to be measured; and
generating an optical spectrum of each light ray to be measured by associating the light ray to be measured that has been selected during measurement with the acquired measurement result.

This reduces a time difference in measurements of the intensity at the same measurement wavelength for the multiple light rays to be measured. As a result, a difference in measurement conditions for the respective multiple light rays to be measured is reduced.

(2) In the non-transitory computer readable medium according to (1) above, the operations may further include selecting the light ray to be measured from among the multiple light rays to be measured. The processor selects the light ray to be measured, so it is not necessary to acquire information specifying the light ray to be measured that is input.

(3) In the non-transitory computer readable medium according to (2) above, the operations may further include, in a first period during which the light intensity at a first wavelength is measured in the sweep, acquiring a measurement result of the light intensity at the first wavelength for at least one light ray to be measured that is selected one-by-one from among the multiple light rays to be measured. This weights the frequency of switching to each light ray to be measured. As a result, the frequency of switching to the light rays to be measured is reduced.

(4) In the non-transitory computer readable medium according to (3) above, the operations may further include, in the first period, acquiring measurement results of the light intensity at the first wavelength for all the multiple light rays to be measured. This allows comparison of the light intensity at the first wavelength for all the light rays to be measured. As a result, a user's convenience is improved.

(5) In the non-transitory computer readable medium according to (3) or (4) above, the operations may further include selecting light rays to be measured so that the number of light rays to be measured that are selected in a second period, during which the light intensity at a second wavelength is measured in the sweep, differs from the number of light rays to be measured that are selected in the first period. This weights the frequency of switching to each light ray to be measured. As a result, the frequency of switching to the light rays to be measured is reduced.

(6) In the non-transitory computer readable medium according to any one of (3) to (5) above, the operations may further include determining, based on accuracy required of measurement of each light ray to be measured, the number of light rays to be measured that are selected in each period during which the light intensity at each wavelength is measured in the sweep. This reduces the frequency of switching to the light rays to be measured, while maintaining the required measurement accuracy.

(7) In the non-transitory computer readable medium according to any one of (1) to (6) above, the operations may further include acquiring a measurement result after an invalid period has elapsed since selecting a single light ray to be measured from among the multiple light rays to be measured and switching to the single light ray to be measured. This maintains or improves the measurement accuracy of the optical spectrum.

(8) In the non-transitory computer readable medium according to any one of (1) to (7) above, the operations may further include, when multiple times of measurements of the light intensity at a measurement wavelength are performed, acquiring, as a measurement result of the light intensity at the measurement wavelength, a value calculated by statistical processing of multiple measurement values acquired in the respective multiple times of measurements. Adopting the statistical value reduces the effects of disturbance such as noise.

(9) An optical spectrum measurement method according to some embodiments is a method of measuring, in a single sweep, optical spectra of multiple light rays to be measured. The optical spectrum measurement method includes:
acquiring a measurement result of the intensity of a light ray to be measured that is selected one-by-one from among the multiple light rays to be measured; and
generating an optical spectrum of each light ray to be measured by associating the light ray to be measured that has been selected during measurement with the acquired measurement result.

This reduces a time difference in measurements of the intensity at the same measurement wavelength for the multiple light rays to be measured. As a result, a difference in measurement conditions for the respective multiple light rays to be measured is reduced.

(10) An optical spectrum analyzer according to some embodiments is configured to generate, in a single sweep, optical spectra of multiple light rays to be measured. The optical spectrum analyzer includes:
at least one measurement unit configured to measure the intensity of a light ray to be measured that is selected one-by-one from among the multiple light rays to be measured; and
a controller configured to generate an optical spectrum of each light ray to be measured, by associating the light ray to be measured that has been selected during measurement of the light intensity by the measurement unit with a measurement result of the light intensity by the measurement unit.

This reduces a time difference in measurements of the intensity at the same measurement wavelength for the multiple light rays to be measured. As a result, a difference in measurement conditions for the respective multiple light rays to be measured is reduced.

(11) The optical spectrum analyzer according to (10) above may further include a switch configured to switch connection so as to input, to the measurement unit, a single light ray to be measured that is selected from the multiple light rays to be measured. The controller may be configured to select, by controlling the switch, the single light ray to be measured that is input to the measurement unit, from among the multiple light rays to be measured. The controller selects the light ray to be measured, so it is not necessary to acquire information specifying the light ray to be measured that is input.

(12) In the optical spectrum analyzer according to (11) above, the switch may be configured to accept input of a trigger signal and switch, in response to the input of the trigger signal, the light ray to be measured that is input to the measurement unit. By switching, in response to the input of the trigger signal from an external apparatus, the light ray to be measured that is input to the measurement unit, it is possible to switch the light ray to be measured, in response to operations of a user program in the external apparatus. As a result, a user's convenience is improved.

(13) In the optical spectrum analyzer according to any one of (10) to (12) above, when there are two or more measurement units, each of the two or more measurement units may be configured to measure the light intensity of a light ray to be measured that is selected one-by-one from among the multiple light rays to be measured. The provision of the two or more measurement units in the optical spectrum analyzer allows parallel measurements of the optical spectra of the multiple light rays to be measured.

The present disclosure relates to an optical spectrum analyzer, an optical spectrum measurement program, and an optical spectrum measurement method that measure optical spectra of multiple light rays to be measured. In the present disclosure, it is assumed that the grating method is used as a measurement method. When measuring an optical spectrum of each light ray to be measured, the optical spectrum analyzer of the grating method rotates a grating at an angle corresponding to each wavelength from a start wavelength to an end wavelength of a measurement wavelength range, and measures the optical spectrum, which is light intensity at respective wavelengths. The operations of rotating the grating at an angle corresponding to each wavelength and measuring the optical spectrum is also referred to as “a sweep.”

Embodiments according to the present disclosure will be described below in comparison with a comparative example.

### Comparison Example

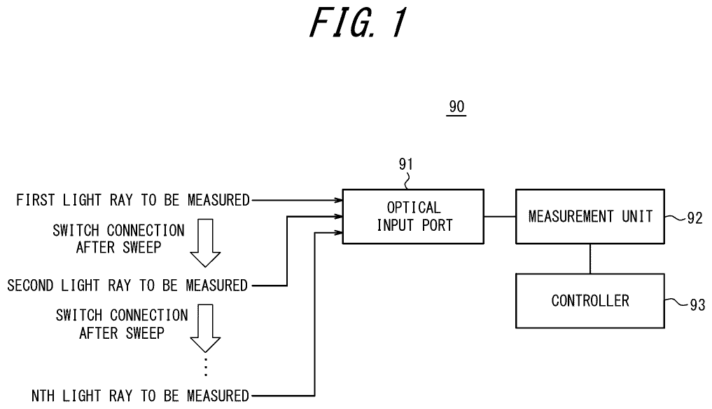

As illustrated in FIG. 1, an apparatus 90 according to the comparison example is provided with an optical input port 91, a measurement unit 92, and a controller 93. In the comparison example, first, second, . . . , and Nth light rays to be measured are sequentially input, as multiple light rays to be measured, to the optical input port 91.

First, a fiber that transmits the first light ray to be measured is connected to the optical input port 91. The measurement unit 92 performs a sweep while the first light ray to be measured is input to the optical input port 91, and measures, for the first light ray to be measured, intensity at each wavelength in a measurement wavelength range. The controller 93 acquires, from the measurement unit 92, a measurement value of the intensity at each wavelength, and generates an optical spectrum of the first light ray to be measured.

After the sweep of the first light ray to be measured is completed, a fiber that transmits the second light ray to be measured is connected to the optical input port 91. In other words, connection to the optical input port 91 is switched to another fiber. The measurement unit 92 performs a sweep while the second light ray to be measured is input to the optical input port 91, and measures, for the second light ray to be measured, intensity at each wavelength in the measurement wavelength range. The controller 93 acquires, from the measurement unit 92, a measurement value of the intensity at each wavelength, and generates an optical spectrum of the second light ray to be measured.

After the sweep of the second light ray to be measured is completed, a fiber that transmits the next light ray to be measured is connected to the optical input port 91. Finally, a fiber that transmits the Nth light ray to be measured is connected to the optical input port 91. The measurement unit 92 performs a sweep while the Nth light ray to be measured is input to the optical input port 91, and measures, for the Nth light ray to be measured, intensity at each wavelength in the measurement wavelength range. The controller 93 acquires, from the measurement unit 92, a measurement value of the intensity at each wavelength, and generates an optical spectrum of the Nth light ray to be measured.

By performing the above operations, the apparatus 90 according to the comparative example can measure the optical spectra of the N number of light rays to be measured, i.e., the first to Nth light rays to be measured.

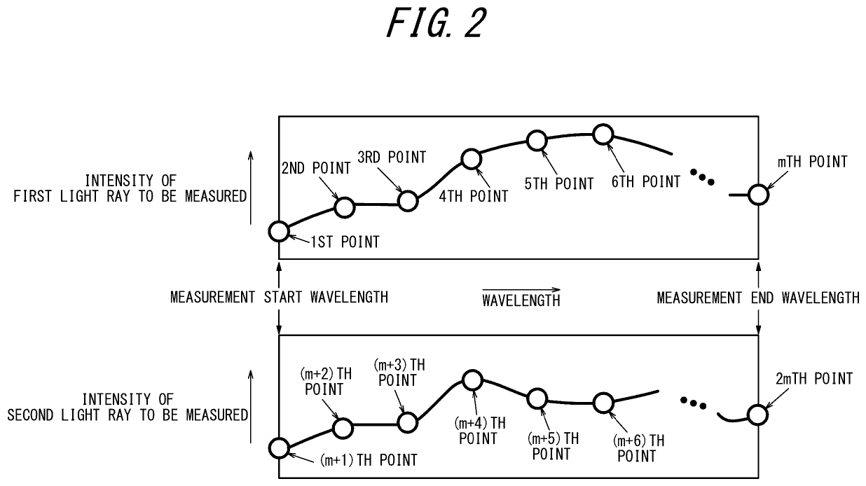

Here, FIG. 2 illustrates results of measurements of the optical spectra of the first and second light rays to be measured, by the apparatus 90 according to the comparative example. When measurement values at m points are acquired in a single sweep, a measurement value of intensity at a measurement start wavelength for the first light ray to be measured corresponds to a measurement value at a first point, and a measurement value of intensity at the measurement start wavelength for the second light ray to be measured corresponds to a measurement value at an (m+1)th point. The time it takes for the apparatus 90 from acquiring the measurement value at the first point to acquiring the measurement value at the (m+1)th point is longer than the time it takes to complete the single sweep. The same is true for the time it takes for the apparatus 90 from acquiring a measurement value at a second point to acquiring a measurement value at an (m+2)th point, which corresponds to the same wavelength of the second light ray to be measured. The same is true for the time it takes for the apparatus 90 from acquiring a measurement value at an mth point, which corresponds to a measurement end wavelength of the first light ray to be measured, to acquiring a measurement value at a 2mth i.e., (m+m)th point, which corresponds to the measurement end wavelength of the second light ray to be measured.

In such a case, in the comparative example, conditions for measuring the intensity at each wavelength for the first light ray to be measured and conditions for measuring the intensity at each wavelength for the second light ray to be measured may differ, due to the fact that conditions for measuring the intensity at each wavelength fluctuate with a lapse of time. The measurement results of the optical spectra under the different measurement conditions cannot be compared correctly. Therefore, when measuring optical spectra of multiple light rays to be measured, it is required to reduce fluctuations in the measurement conditions.

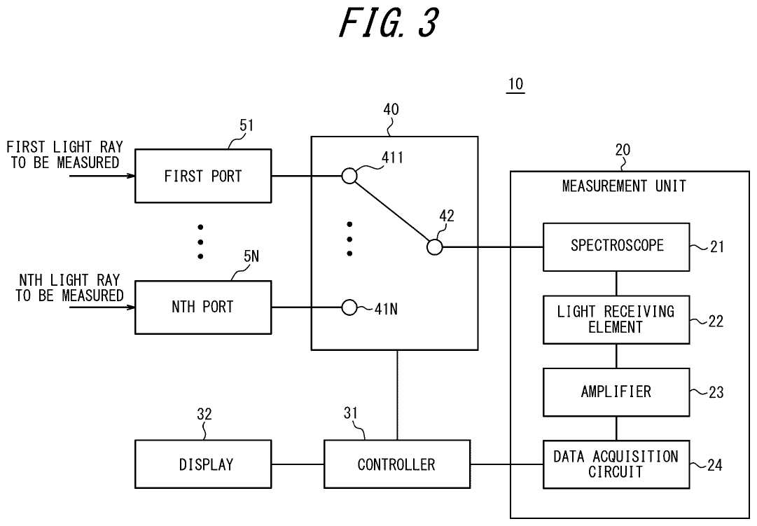

In the present disclosure, an optical spectrum measurement program, an optical spectrum measurement method, and an optical spectrum analyzer 10 (see FIG. 3) that can reduce fluctuations in measurement conditions of optical spectra will be described below.

### Example Configuration of Optical Spectrum Analyzer 10

As illustrated in FIG. 3, the optical spectrum analyzer 10 according to an embodiment of the present disclosure is provided with a measurement unit 20, a controller 31, a display 32, an optical switch 40, and an optical input interface including an N number of ports from first to Nth ports 51 to 5N.

Each of the N number of ports, from the first to Nth ports 51 to 5N, of the optical input interface is configured to be able to input a light ray to be measured by the optical spectrum analyzer 10. To the first port 51, a fiber that transmits a first light ray to be measured is connected. To the Nth port 5N, a fiber that transmits an Nth light ray to be measured is connected.

The optical switch 40 is provided with terminals 411 to 41N and a terminal 42. The terminals 411 to 41N are connected to the first to Nth ports 51 to 5N, respectively. The terminal 42 is configured to be switchable to be connected to any of the terminals 411 to 41N. By switching the terminal 42 to be connected to any one of the terminals 411 to 41N in the optical switch 40, a light ray to be input to the measurement unit 20 is switched to any one of the first to Nth light rays to be measured. The optical switch 40 is also referred to as a switching unit.

The terminal 42 may select a terminal to connect from among the terminals 411 to 41N, based on a control instruction from the controller 31. In other words, the controller 31 may control which terminal the terminal 42 is connected to among the terminals 411 to 41N. The terminal 42 may select a terminal to connect from among the terminals 411 to 41N, based on a control instruction from an apparatus connected externally to the optical spectrum analyzer 10. When the controller 31 does not control a connection destination of the terminal 42, the controller 31 may acquire, from the optical switch 40, information specifying the connection destination of the terminal 42.

The measurement unit 20 is provided with a spectroscope 21, a light receiving element 22, an amplifier 23, and a data acquisition circuit 24. The spectroscope 21 separates a light ray to be measured into light of each wavelength, and passes light of a wavelength to be detected so that the light is incident on the light receiving element 22. In the present disclosure, a grating is used as the spectroscope 21. The light receiving element 22 detects the incident light that has passed through the spectroscope 21, and outputs a signal corresponding to the intensity of the incident light. The amplifier 23 amplifies the signal output from the light receiving element 22, and outputs the amplified signal to the data acquisition circuit 24. The data acquisition circuit 24 synchronizes the wavelength of the light that has passed through the spectroscope 21 with the amplified signal, to acquire a measurement value of the intensity at each wavelength.

The controller 31 acquires, from the measurement unit 20, the measurement value of the intensity at each wavelength for the light ray to be measured, and generates an optical spectrum of the light ray to be measured. The controller 31 may control a sweeping operation of the measurement unit 20. The measurement unit 20 may perform a sweep by moving the grating on control instructions from the controller 31, and measure the light intensity at each wavelength in a measurement wavelength range.

The controller 31 may be configured with a processor such as a central processing unit (CPU), for example. The controller 31 may realize predetermined functions by causing the processor to execute a predetermined program. The controller 31 may be configured with a dedicated circuit such as a field programmable gate array (FPGA), for example.

The controller 31 may include a memory. The memory stores various information to be used in operations of the optical spectrum analyzer 10, programs to realize the functions of the optical spectrum analyzer 10, or the like. The memory may function as working memory of the controller 31. The memory may be configured with, for example, a semiconductor memory or the like. The memory may be configured with a volatile memory or a non-volatile memory. At least part of the memory may be configured as a memory device connected externally to the optical spectrum analyzer 10.

The controller 31 may be realized as a computer such as a desktop personal computer (PC) or a notebook PC connected externally to the optical spectrum analyzer 10.

The display 32 displays the waveforms of optical spectra of the light rays to be measured. The display 32 may be configured with any type of display, such as a liquid crystal display. The display 32 may be configured as a touch panel display that displays a graphical user interface (GUI), which functions as an input device, and accepts input from a user. In other words, the display 32 may be configured integrally with an input device.

The optical spectrum analyzer 10 may be provided with an input device that accepts operation input from the user. The input device may include a keyboard or physical keys, or include a touch panel or a touch sensor, or a pointing device such as a mouse. The input device may be configured as a touch panel display that is integrated with the display 32, as described above.

### Example Operations of Optical Spectrum Analyzer 10

Specific example operations of the optical spectrum analyzer 10 according to the present disclosure will be described below.

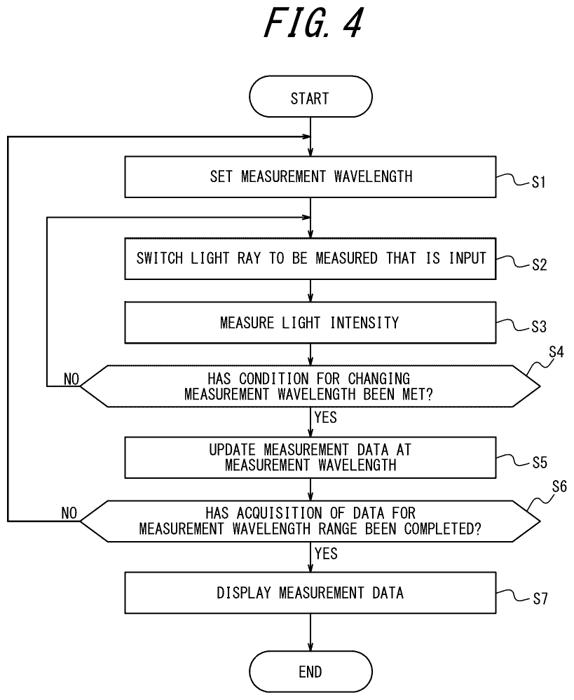

The optical spectrum analyzer 10 may perform an optical spectrum measurement method, including a procedure of the flowchart illustrated in FIG. 4. The optical spectrum measurement method may be implemented as an optical spectrum measurement program to be executed by the optical spectrum analyzer 10. The optical spectrum measurement program may be stored on a non-transitory computer readable medium.

The controller 31 of the optical spectrum analyzer 10 sets a measurement wavelength, which is a target wavelength at which intensity is measured, in order to measure the intensity at each wavelength as an optical spectrum of a light ray to be measured (step S1). The controller 31 first sets the measurement wavelength to a measurement start wavelength of a measurement wavelength range. The controller 31 controls the grating of the spectroscope 21, according to the set value of the measurement wavelength.

The optical spectrum analyzer 10 switches a light ray to be measured that is input to the measurement unit 20 (step S2). The light ray to be measured that is input to the measurement unit 20 is determined according to a connection destination of the terminal 42 of the optical switch 40. The controller 31 of the optical spectrum analyzer 10 may switch the light ray to be measured that is input to the measurement unit 20, by controlling the optical switch 40 by the controller 31 itself. In other words, the controller 31 may select the light ray to be measured that is input to the measurement unit 20 one-by-one from among multiple light rays to be measured, which are input to the optical switch 40, and may switch the connection of the optical switch 40 by controlling the optical switch 40 so that the selected light ray to be measured is input to the measurement unit 20. When the controller 31 controls the optical switch 40 by itself, the controller 31 can recognize which light ray to be measured is input to the measurement unit 20. As a result, the controller 31 does not need to acquire information specifying the light ray to be measured.

When the controller 31 does not control the connection destination of the optical switch 40, the controller 31 may recognize which light ray to be measured is input to the measurement unit 20 by acquiring, from the optical switch 40, information specifying the connection destination of the terminal 42 of the optical switch 40. In other words, by acquiring the information specifying the connection destination of the terminal 42, the controller 31 may check whether the light ray to be measured that is input to the measurement unit 20 by an apparatus connected externally to the optical spectrum analyzer 10 has been switched.

The measurement unit 20 of the optical spectrum analyzer 10 measures the light intensity of the light ray to be measured that is input to the measurement unit 20, at the measurement wavelength set in the operation of step S1 (step S3).

The controller 31 determines whether a condition for changing the measurement wavelength has been met (step S4). The condition for changing the measurement wavelength may be that measurements of light intensity for light rays to be measured, which are targets of the measurements at the set measurement wavelength, have been completed. The completion of the measurements of the light intensity for the light rays to be measured, which are the targets of the measurements at the set measurement wavelength, may be associated with the number of pulses transmitted to a motor, which rotates the grating, to drive the motor having reached a specified number, i.e., the rotation angle of the grating having reached a specified angle. The condition for changing the measurement wavelength may be input of a trigger signal to instruct the optical spectrum analyzer 10 to change the measurement wavelength.

The condition for changing the measurement wavelength may be, for example, a lapse of time set as time for changing the measurement wavelength. The time for changing the measurement wavelength may be set to the time it takes for the rotation angle of the grating to reach a specified angle. The time for changing the measurement wavelength may be set according to the time it takes to perform a sweep. For example, the time for changing the measurement wavelength may be set to the time that the time it takes to perform a sweep is divided by the number of wavelengths set as measurement wavelengths. The time for changing the measurement wavelength may be set to the time required to complete the measurements of the light intensity at the measurement wavelength for the respective multiple light rays to be measured. The controller 31 may determine that the time after setting the measurement wavelength has reached the time for changing the measurement wavelength when the measurements of the light intensity at the set measurement wavelength for the light rays to be measured, which are the targets of the measurements at the set measurement wavelength, have been completed.

When the condition for changing the measurement wavelength has not been met (step S4: NO), the operation returns to step S2, and the controller 31 switches the light ray to be measured that is input to the measurement unit 20 so that the intensity of the multiple light rays to be measured is measured at the set measurement wavelength.

When the condition for changing the measurement wavelength is met (step S4: YES), the controller 31 completes the measurements of the light intensity at the set measurement wavelength, and updates measurement data at the set measurement wavelength (step S5). By performing the operations from step S1 to step S5, the optical spectrum analyzer 10 can acquire a measurement result of the intensity of the light ray to be measured that is selected one-by-one from among the multiple light rays to be measured. In addition, the optical spectrum analyzer 10 can associate the light ray to be measured that has been selected during the measurement by the measurement unit 20 with the measurement result of the intensity acquired by the measurement unit 20. Upon performing the operation of updating the measurement data in step S5, the controller 31 may generate measurement data on an optical spectrum of each of the multiple light rays to be measured, based on data that associates the light ray to be measured that has been selected during the measurement by the measurement unit 20 and the measurement result of the intensity acquired by the measurement unit 20, which is acquired so far, and may display the measurement data on the display 32.

The controller 31 determines whether the acquisition of data for the measurement wavelength range has been completed (step S6). The controller 31 determines that the acquisition of the data for the measurement wavelength range has been completed when a measurement end wavelength of the measurement wavelength range is set to the measurement wavelength and the measurements of the light intensity at the measurement end wavelength have been completed.

When the acquisition of the data for the measurement wavelength range has not been completed (step S6: NO), the operation returns to step S1, and the controller 31 re-sets the measurement wavelength to the next wavelength in the measurement wavelength range, and measures intensity at the re-set measurement wavelength for the multiple light rays to be measured.

When the acquisition of the data for the measurement wavelength range has been completed (step S6: YES), the controller 31 generates measurement data on optical spectra of the multiple light rays to be measured, and displays the measurement data on the display 32 (step S7). By performing the operation in step S7, the optical spectrum analyzer 10 can generate the optical spectrum of each of the multiple light rays to be measured, based on the data that associates the light ray to be measured that has been selected during the measurement by the measurement unit 20 and the measurement result of the intensity acquired by the measurement unit 20. After performing the operation in step S7, the controller 31 terminates the execution of the flowchart in FIG. 4. Even while acquiring the data for the measurement wavelength range, for example, at any timing such as when performing the operation of updating the measurement data in step S5, the controller 31 may generate the measurement data on the optical spectrum of each of the multiple light rays to be measured, based on the data acquired up to that timing, and display the measurement data on the display 32.

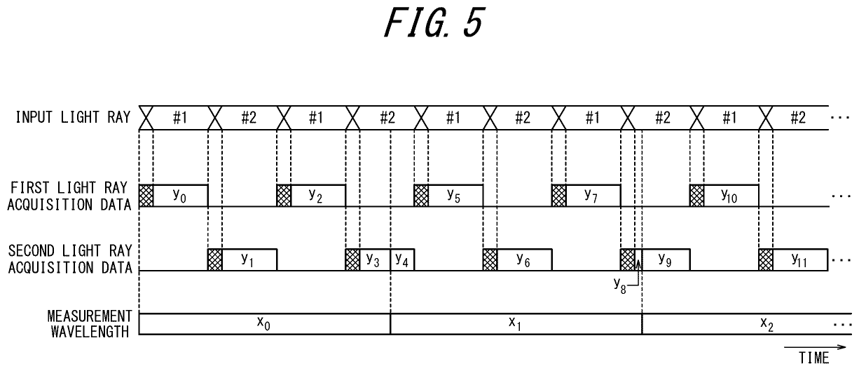

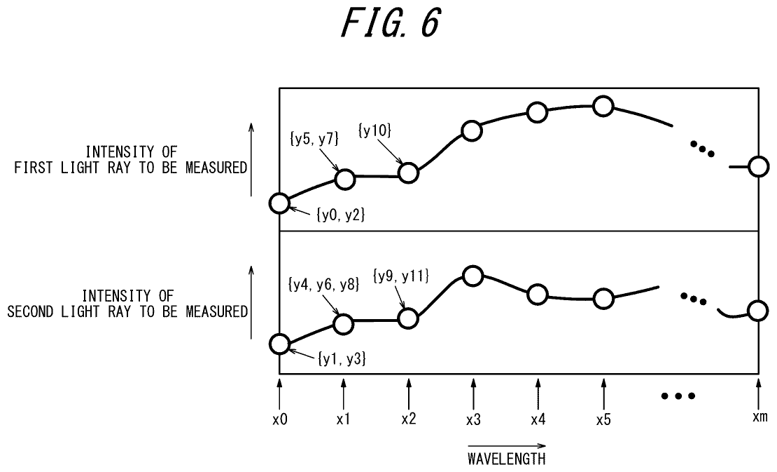

An example of operations for acquiring the measurement data, by performing the above-described operations, will be described with reference to FIGS. 5 and 6. In this example, the optical spectrum analyzer 10 measures, in a single sweep, optical spectra of two light rays to be measured, i.e., first and second light rays to be measured.

As illustrated in the timing chart in FIG. 5, the measurement wavelength is assumed to be sequentially set to x₀, x₁, and x₂. The setting of the measurement wavelength corresponds to the operation in step S1 of FIG. 4. On the other hand, light (input light) to be input to the measurement unit 20 is switched between the first light ray to be measured (#1) and the second light ray to be measured (#2). The switching of the light ray to be input to the measurement unit 20 corresponds to the operation in step S2 of FIG. 4.

In a period during which the measurement wavelength is set to x₀, the light ray to be input to the measurement unit 20 is first switched to the first light ray to be measured. The measurement unit 20 measures, for the first light ray to be measured, the intensity (y₀) of a wavelength component of x₀. The measurement of the intensity of the wavelength component of x₀ for the first light ray to be measured corresponds to the operation in step S3 of FIG. 4. Measurement data on the first light ray to be measured is represented as first light ray acquisition data. In addition, x₀ corresponds to a measurement start wavelength.

Here, the first light ray acquisition data includes data represented by a rectangle with diagonal grid hatching before data represented by y₀. This data is data that is measured in a period until the switching of the light ray to be input to the measurement unit 20 is completed. The period until the switching of the light ray to be input to the measurement unit 20 is completed may be set as a period during which the intensity of the light ray to be input to the measurement unit 20 is unstable. Measurement data in the period during which the intensity of the light ray to be input to the measurement unit 20 is unstable reduces the measurement accuracy of the optical spectrum. Therefore, the data in the period during which the intensity of the light ray to be input to the measurement unit 20 is unstable is treated as invalid data. The period during which the measurement data is invalid, i.e., the period during which the intensity of the light ray to be input to the measurement unit 20 is unstable is also referred to as an invalid period. The controller 31 may acquire a measurement result, after the invalid period has elapsed since selecting a single light ray to be measured from among the multiple light rays to be measured and switching to the single light ray to be measured. The measurement accuracy of the optical spectrum is thereby maintained or improved.

When the measurement unit 20 has completed measuring the data represented by y₀, the time after the measurement wavelength has been set to x₀ has not yet reached the time for changing the measurement wavelength. This case corresponds to the case of NO in step S4 of FIG. 4. Therefore, in correspondence with the operation in step S2 of FIG. 4, the light ray to be input to the measurement unit 20 is switched to the second light ray to be measured. The measurement unit 20 measures, for the second light ray to be measured, the intensity (y₁) of a wavelength component of x₀. The measurement of the intensity of the wavelength component of x₀ for the second light ray to be measured corresponds to the operation in step S3 of FIG. 4. Measurement data on the second light ray to be measured is referred to as second light ray acquisition data. The second light ray acquisition data also includes invalid data.

When the measurement unit 20 has completed the measurement of the data represented by y₁, the time after the measurement wavelength has been set to x₀ has not yet reached the time for changing the measurement wavelength. This case corresponds to the case of NO in step S4 of FIG. 4. Therefore, in correspondence with the operation in step S2 of FIG. 4, the light ray to be input to the measurement unit 20 is switched again to the first light ray to be measured. The measurement unit 20 measures, for the first light ray to be measured, the intensity (y₂) of the wavelength component of x₀. Furthermore, the light ray to be input to the measurement unit 20 is switched to the second light ray to be measured. The measurement unit 20 measures, for the second light ray to be measured, the intensity (y₃) of the wavelength component of x₀.

While the intensity of the wavelength component of x₀ for the second light ray to be measured is being measured, it is assumed that the time after the measurement wavelength has been set to x₀ has reached the time for changing the measurement wavelength. This case corresponds to the case of YES in step S4 of FIG. 4. The controller 31 updates, in accordance with the operation in step S5 of FIG. 4, measurement data on the intensity at the measurement wavelength (x₀) for the first and second light rays to be measured, based on the measurement data that has been measured so far by setting the measurement wavelength to x₀.

As illustrated in FIG. 6 as a graph of the measurement waveform of an optical spectrum, the intensity of the component with a wavelength of x₀ for the first light ray to be measured is calculated based on a set of measurement data with elements y₀ and y₂, and then plotted. The intensity of the component with a wavelength of x₀ for the second light ray to be measured is calculated based on a set of measurement data with elements y₁ and y₃, and then plotted.

When the number of elements in the measurement data on the light intensity is one, the value of that element may be adopted as is as the measurement data on the light intensity. When the number of elements in the measurement data on the light intensity is two or more, a statistical value calculated by performing statistical processing of the values of the elements may be adopted as the measurement data on the light intensity. The statistical value may be, for example, an average value of the multiple elements, or a maximum or minimum value among the multiple elements. Adopting the statistical value reduces the effects of disturbance such as noise. The maximum or minimum value can be easily calculated by holding the measurement value to the maximum or minimum value. Therefore, adopting the maximum or minimum value as the statistical value reduces a calculation load.

Returning to the timing chart in FIG. 5, since the set measurement wavelength is x₀, the acquisition of data in the measurement wavelength range has not yet been completed. This case corresponds to the case of NO in step S6 of FIG. 4. Therefore, the measurement wavelength is re-set to x₁ in accordance with the operation in step S1 of FIG. 4.

The measurement unit 20 measures, for the second light ray to be measured, the intensity (y₄) of a wavelength component of x₁ while the second light ray to be measured is still being input. The measurement of the intensity of the wavelength component of x₁ for the second light ray to be measured corresponds to the operation in step S3 of FIG. 4. As in the period during which the set wavelength is set to x₀, the light ray to be input to the measurement unit 20 is switched between the first and second light rays to be measured in a period during which the set wavelength is set to x₁. The measurement unit 20 measures the intensity (y₅ and y₇) of a wavelength component of x₁ for the first light ray to be measured. The measurement unit 20 measures the intensity (y₄, y₆, and y₈) of a wavelength component of x₁ for the second light ray to be measured.

The controller 31 updates measurement data on the intensity at the measurement wavelength (x₁) for the first and second light rays to be measured, based on the measurement data that has been measured by setting the measurement wavelength to x₁. As illustrated in FIG. 6, the intensity of the component with a wavelength of x₁ for the first light ray to be measured is calculated based on a set of measurement data with elements y₅ and y₇, and then plotted. The intensity of the component with a wavelength of x₁ for the second light ray to be measured is calculated based on a set of measurement data with elements y₄, y₆, and y₈, and then plotted.

Returning to the timing chart in FIG. 5, the measurement wavelength is re-set to x₂. Even in a period during which the set wavelength is set to x₂, the light ray to be input to the measurement unit 20 is switched between the first and second light rays to be measured. The measurement unit 20 measures the intensity (y₁₀) of a wavelength component of x₂ for the first light ray to be measured. The measurement unit 20 measures the intensity (y₉ and y₁₁) of a wavelength component of x₂ for the second light ray to be measured.

The controller 31 updates measurement data on the intensity at the measurement wavelength (x₂) for the first and second light rays to be measured, based on the measurement data that has been measured by setting the measurement wavelength to x₂. As illustrated in FIG. 6, the intensity of the component with a wavelength of x₂ for the first light ray to be measured is calculated based on a set of measurement data with an element y₁₀, and then plotted. The intensity of the component with a wavelength of x₂ for the second light ray to be measured is calculated based on a set of measurement data with elements y₉ and y₁₁, and then plotted.

Operations of re-setting the measurement wavelength and measuring the intensity at each measurement wavelength for the light rays to be measured are repeated until the measurement wavelength is set to a measurement end wavelength of xₘ and the measurement data on the intensity at the measurement wavelength (xₘ) is updated, that is, until a single sweep is completed. Measuring the intensity for both the first and second light rays to be measured until the single sweep is completed allows generation of the measurement waveform of the optical spectrum of each of the first and second light rays to be measured in the single sweep, as illustrated in FIG. 6.

In the above-described example operations, the measurement wavelength is changed during the measurement of the intensity for the second light ray to be measured. The controller 31 may switch the light ray to be measured when the measurement wavelength is changed. The controller 31 may change the measurement wavelength after waiting for the completion of the measurement of the light ray to be measured. In other words, the controller 31 may synchronize the change of the measurement wavelength with the switching of the light ray to be measured.

As described above, by performing the optical spectrum measurement method according to the present disclosure, in the single sweep, the intensity at a single measurement wavelength is measured for the multiple light rays to be measured. In addition, the optical spectra of the multiple light rays to be measured are measured in the single sweep. The optical spectra of the multiple light rays to be measured can be measured in the single sweep, so a time difference when the intensity at a single measurement wavelength is measured for the respective light rays to be measured becomes short.

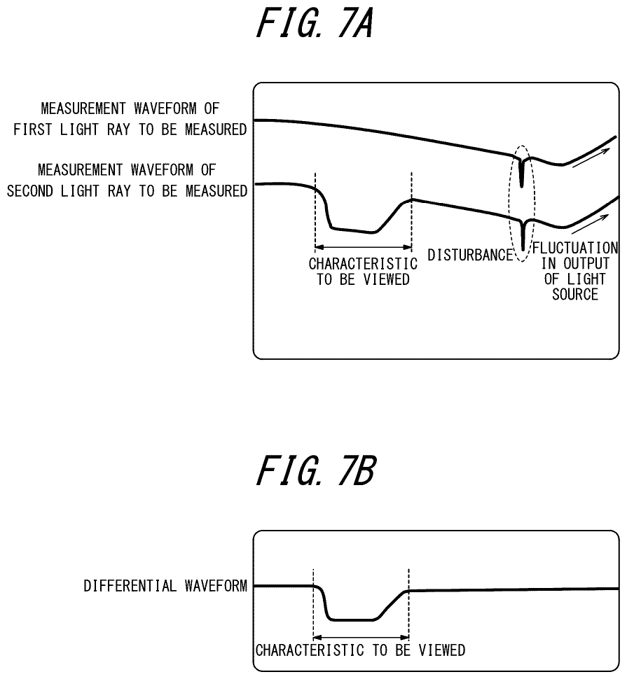

For example, as illustrated in FIG. 7A, it is assumed that the measurements of the light intensity are affected by disturbance in the sweep. In the optical spectrum measurement method according to the present disclosure, the time difference between the measurements of the intensity at the same measurement wavelength for the respective first and second light rays to be measured is short, so when the measurements are affected by disturbance, the disturbance appears in the measurement waveforms of both the first and second light rays to be measured.

In addition, it is assumed that output of light sources of the light rays to be measured fluctuates due to a drift or the like in the sweep, and that the light intensity is affected by the fluctuation in the output of the light sources. In this case, the time difference between the measurements of the intensity at the same measurement wavelength for the respective first and second light rays to be measured is short, so when the measurements are affected by the fluctuation in the output of the light sources, the effect of the fluctuation in the output of the light sources appears in common in the measurement waveforms of both the first and second light rays to be measured.

As illustrated in FIG. 7B, when a differential waveform is generated between the measurement waveforms of the first and second light rays to be measured, the effects of the disturbance and the fluctuation in the output of the light sources appear in common in the waveforms of both the first and second light rays to be measured. In other words, the difference between measurement conditions for the optical spectrum of the first light ray to be measured and measurement conditions for the optical spectrum of the second light ray to be measured becomes small.

The waveforms that appear in both the measurement waveforms of the first and second light rays to be measured are canceled out in the differential waveform. By canceling out the waveforms that appear in common in the differential waveform, the differential waveform only contains a waveform expressing a characteristic to be viewed when the first and second light rays to be measured are compared. As a result, the optical spectra of the first and second light rays to be measured are compared correctly.

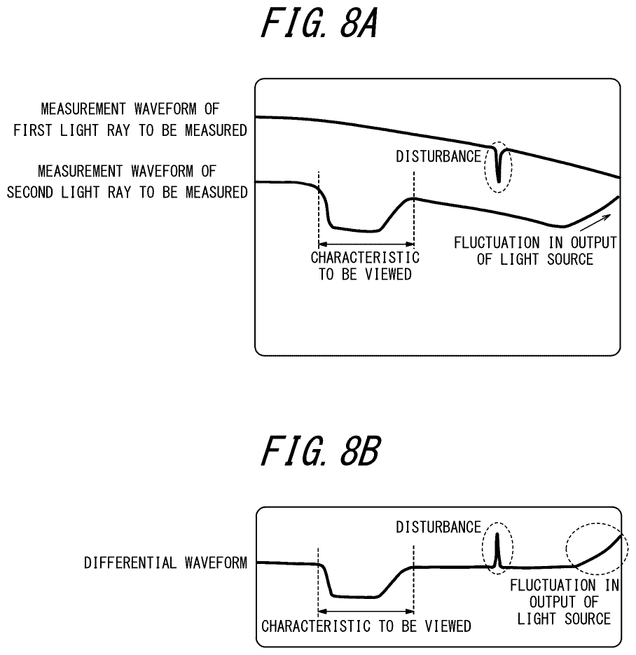

In a method according to the comparative example, a first sweep to measure the optical spectrum of the first light ray to be measured and a second sweep to measure the optical spectrum of the second light ray to be measured are performed. In the comparative example, since the time difference between the first sweep and the second sweep is large, the time difference between the measurements of the intensity at the same measurement wavelength is larger than the time difference between the measurements of the intensity at the same measurement wavelength in the optical spectrum measurement method according to the present disclosure. According to the method of the comparative example, due to the large time difference between the measurements of the intensity at the same measurement wavelength, the effect of disturbance appears only in the measurement waveform of the first light ray to be measured, as illustrated in FIG. 8A. In addition, the effect of fluctuation in the output of the light source appears only in the measurement waveform of the second light ray to be measured.

As illustrated in FIG. 8B, when a differential waveform is generated between the measurement waveforms of the first and second light rays to be measured, the differential waveform contains waveforms causing by the disturbance and the fluctuation in the output of the light source, in addition to a waveform expressing a characteristic to be viewed. In other words, according to the method of the comparative example, the difference between measurement conditions for the optical spectrum of the first light ray to be measured and measurement conditions for the optical spectrum of the second light ray to be measured becomes large. As a result, according to the method of the comparative example, it becomes difficult to correctly compare the optical spectra of the first and second light rays to be measured.

As described above, the optical spectrum measurement method according to the present disclosure can reduce the difference among the measurement conditions for the respective multiple light rays to be measured, as compared to the method according to the comparative example. As a result, the optical spectrum measurement method according to the present disclosure can improve the accuracy of comparison among the optical spectra of the multiple light rays to be measured, as compared to the method according to the comparative example.

### OTHER EMBODIMENTS

Other embodiments of the optical spectrum analyzer 10 and the optical spectrum measurement method according to the present disclosure will be described below.

### <Frequency of Switching Among Multiple Light Rays to Be Measured>

The number of light rays to be measured that are switched while the measurement wavelength is set to one wavelength may be the same or different. In other words, for each measurement wavelength, the number of light rays to be measured may be the same or different. For example, when the multiple light rays to be measured by the optical spectrum analyzer 10 include a light ray that needs to be measured with high accuracy and a reference light ray that does not need to be measured with high accuracy, the controller 31 may cause the light ray that needs to be measured with high accuracy to be input to the measurement unit 20 with a higher frequency than the frequency of causing the light ray that does not need to be measured with high accuracy to be input to the measurement unit 20. In other words, the controller 31 may weight the frequency of switching each light ray to be measured, according to the purpose of measuring each light ray to be measured.

In a single sweep, for example, the controller 31 may set the measurement wavelength to a first wavelength, and measure light intensity at the first wavelength. A period during which the measurement wavelength is set to the first wavelength is also referred to as a first period. In the first period, the controller 31 may select at least one light ray to be measured one-by-one from among the multiple light rays to be measured that are input to the optical switch 40, and acquire, from the measurement unit 20, a measurement result of the light intensity at the first wavelength for the at least one selected light ray to be measured. For example, the controller 31 may select the light ray that needs to be measured with high accuracy in the first period, and may not select the light ray that does not need to be measured with high accuracy. The frequency of switching each light ray to be measured is thereby weighted.

In the first period, the controller 31 may select every light ray to be measured, from among the multiple light rays to be measured, at least once, and measure the light intensity at the first wavelength for every light ray to be measured. Thereby, the light intensity at the first wavelength can be compared for every light ray to be measured. As a result, the user's convenience is improved.

The controller 31 may set the measurement wavelength to a second wavelength, which is different from the first wavelength, and measure light intensity at the second wavelength. A period during which the measurement wavelength is set to the second wavelength is also referred to as a second period. Also in the second period, the controller 31 may select at least one light ray to be measured from among the multiple light rays to be measured, and acquire, from the measurement unit 20, a measurement result of the light intensity at the second wavelength for the at least one selected light ray to be measured.

Also in the second period, the controller 31 may select every light ray to be measured, from among the multiple light rays to be measured, at least once, and measure the light intensity at the second wavelength for every light ray to be measured.

The controller 31 may select light rays to be measured in each of the first and second periods, so that the number of light rays to be measured that are selected in the first period to measure light intensity at the first wavelength is different from the number of light rays to be measured that are selected in the second period to measure light intensity at the second wavelength. For example, the controller 31 may select the light ray to be measured that needs to be measured with high accuracy in both the first and second periods, and select the light ray to be measured that does not need to be measured with high accuracy in either the first or second period. In other words, the controller 31 may determine the number of light rays to be measured that are selected in each period, during which light intensity at each wavelength is measured in the sweep, based on accuracy required of measurements of each light ray to be measured. This reduces the frequency of switching among the light rays to be measured while maintaining the required measurement accuracy.

Weighting the frequency of switching among the light rays to be measured reduces the frequency of switching in the single sweep among the light rays to be measured. As a result, the time required for the single sweep is reduced. In addition, while suppressing the total number of times the light rays to be measured are switched in the single sweep, it is possible to perform measurements only for the light ray to be measured that needs to be measured with high accuracy, at finely divided measurement wavelengths.

### <Switching of Optical Switch 40 by Trigger Signal>

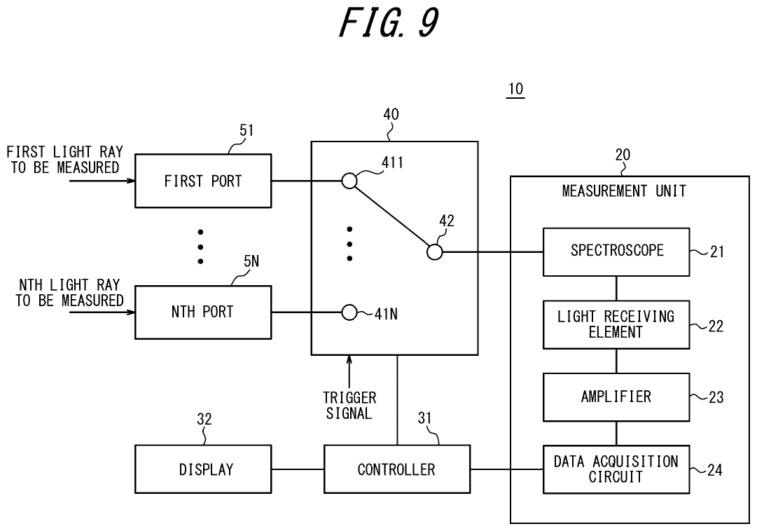

As illustrated in FIG. 9, the optical switch 40 may be configured to accept input of a trigger signal from an apparatus connected externally to the optical spectrum analyzer 10. The optical switch 40 may be configured to switch a light ray to be input to the measurement unit 20, in response to the input of the trigger signal. For example, when the first and second light rays to be measured are input to the optical switch 40, the optical switch 40 switches the light ray to be input to the measurement unit 20 between the first and second light rays to be measured, in response to the input of the trigger signal. The trigger signal may be a pulse signal. When the trigger signal rises, the optical switch 40 may switch the light ray to be input to the measurement unit 20 between the first and second light rays to be measured. When the trigger signal falls, the optical switch 40 may switch the light ray to be input to the measurement unit 20 between the first and second light rays to be measured.

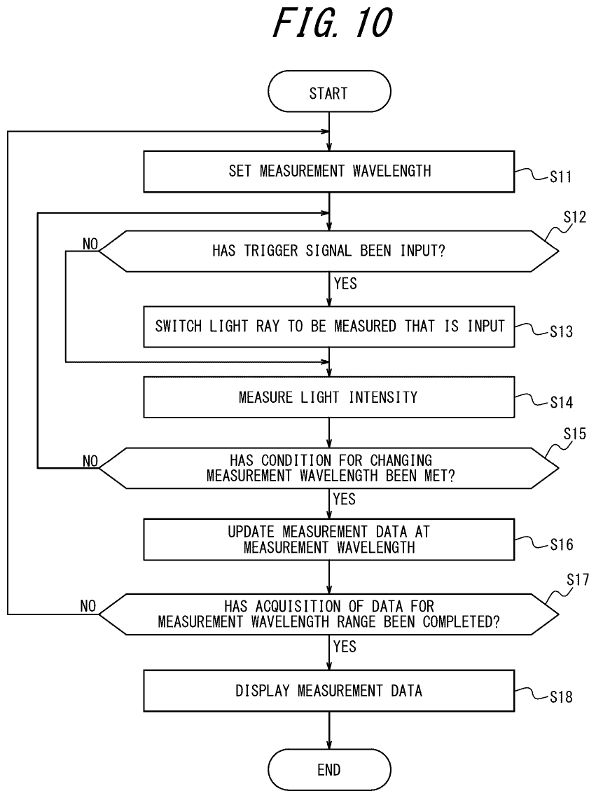

When the optical switch 40 is configured to switch the light ray to be input to the measurement unit 20 in response to the input of the trigger signal, the optical spectrum analyzer 10 may perform an optical spectrum measurement method, including a procedure of the flowchart illustrated in FIG. 10. The optical spectrum measurement method may be implemented as an optical spectrum measurement program to be executed by the optical spectrum analyzer 10. The optical spectrum measurement program may be stored on a non-transitory computer readable medium.

The controller 31 of the optical spectrum analyzer 10 sets a measurement wavelength (step S11). The measurement wavelength may be set in the same manner as the operation in step S1 of FIG. 4.

The optical switch 40 of the optical spectrum analyzer 10 determines whether a trigger signal has been input (step S12). When the trigger signal has been input (step S12: YES), the optical switch 40 switches the light ray to be measured that is input to the measurement unit 20 (step S13). The switching of the light ray to be measured that is input to the measurement unit 20 may be performed in the same manner as the operation in step S2 of FIG. 4. When no trigger signal has been input (step S12: NO), the optical switch 40 does not perform the operation for switching the light ray to be measured in step S13, and the operation proceeds to step S14.

The measurement unit 20 of the optical spectrum analyzer 10 measures light intensity at the measurement wavelength set in the operation of step S11 for the light ray to be measured that is input to the measurement unit 20 (step S14). The light intensity at the measurement wavelength may be measured in the same manner as the operation of step S3 in FIG. 4.

The controller 31 determines whether a condition for changing the measurement wavelength has been met (step S15). The determination may be performed in the same manner as the operation in step S4 of FIG. 4. When the condition for changing the measurement wavelength has not been met (step S15: NO), the controller 31 returns to step S12, and switches the light ray to be measured that is input to the measurement unit 20 when the trigger signal has been input.

When the condition for changing the measurement wavelength has been met (step S15: YES), the controller 31 completes measurements of the light intensity at the set measurement wavelength, and updates measurement data at the set measurement wavelength (step S16). The measurement data may be updated in the same manner as the operation in step S5 of FIG. 4. Upon performing the operation of updating the measurement data in step S16, the controller 31 may generate measurement data on an optical spectrum of each of the multiple light rays to be measured, based on data that associates the light ray to be measured that has been selected during the measurement by the measurement unit 20 and a measurement result of the intensity acquired by the measurement unit 20, which is acquired so far, and may display the measurement data on the display 32.

The controller 31 determines whether acquisition of data for a measurement wavelength range has been completed (step S17). The determination may be performed in the same manner as the operation in step S6 of FIG. 4. When the acquisition of data for the measurement wavelength range has not been completed (step S17: NO), the operation returns to step S11, and the controller 31 re-sets the measurement wavelength to the next wavelength in the measurement wavelength range, and measures intensity at the re-set measurement wavelength for the multiple light rays to be measured.

When the acquisition of data for the measurement wavelength range has been completed (step S17: YES), the controller 31 displays, on the display 32, the measurement data on the optical spectra of the multiple light rays to be measured (step S18). The measurement data may be displayed in the same manner as the operation in step S7 of FIG. 4. After carrying out the operation in step S18, the controller 31 terminates the execution of the flowchart in FIG. 10. Even while acquiring the data for the measurement wavelength range, for example, at any timing such as when performing the operation of updating the measurement data in step S16, the controller 31 may generate the measurement data on the optical spectrum of each of the multiple light rays to be measured, based on the data acquired up to that timing, and display the measurement data on the display 32.

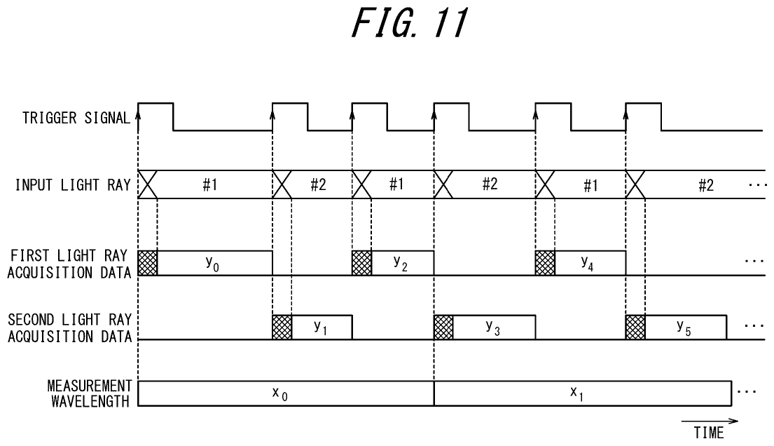

An example of operations of acquiring measurement data by switching the light ray to be measured that is input to the measurement unit 20 by inputting a trigger signal to the optical switch 40 will be described with reference to the timing chart in FIG. 11. In this example of the operations, the optical spectrum analyzer 10 measures, in a single sweep, optical spectra of two light rays to be measured, i.e., first and second light rays to be measured.

As illustrated in FIG. 11, the measurement wavelength is sequentially set to x₀ and x₁. The setting of the measurement wavelength corresponds to the operation in step S11 of FIG. 10. On the other hand, the light (input light) input to the measurement unit 20 is switched to either the first light ray to be measured (#1) or the second light ray to be measured (#2) at rising edges of the trigger signal. The input of the trigger signal corresponds to the operation in step S12 of FIG. 10. The switching of the light ray to be input to the measurement unit 20 corresponds to the operation in step S13 of FIG. 10.

In a period during which the measurement wavelength is set to x₀, the light ray to be input to the measurement unit 20 is switched between the first and second light rays to be measured. The measurement unit 20 measures, for the first light ray to be measured, the intensity (y₀ and y₂) of a wavelength component of x₀. The measurement unit 20 measures, for the second light ray to be measured, the intensity (y₁) of a wavelength component of x₀. The measurements of the intensity of the first and second light rays to be measured correspond to the operation in step S14 of FIG. 10. The measurement data on the first light ray to be measured is represented as first light ray acquisition data. The measurement data on the second light ray to be measured is represented as second light ray acquisition data.

After the measurement of the intensity (y₂), the measurement wavelength is re-set to x₁. The measurement unit 20 measures, for the first light ray to be measured, the intensity (y₄) of a wavelength component of x₁. The measurement unit 20 measures, for the second light ray to be measured, the intensity (y₃ and y₅) of a wavelength component of x₁.

Operations of re-setting the measurement wavelength and measuring the intensity at each measurement wavelength for the light rays to be measured are repeated until the measurement wavelength is set to a measurement end wavelength and the measurement data on the intensity at each measurement wavelength in a measurement wavelength range is updated, that is, until a single sweep is completed. Measuring the intensity of both the first and second light rays to be measured until the single sweep is completed allows, in the single sweep, generation of the measurement waveform of the optical spectrum of each of the first and second light rays to be measured.

As described above, the optical spectrum analyzer 10 may be configured to switch the light ray to be measured that is input to the measurement unit 20 in response to the input of the trigger signal from the external apparatus. The external apparatus may be a computer used by the user of the optical spectrum analyzer 10. For example, the user of the optical spectrum analyzer 10 may run, on the external apparatus, a user program that changes light rays to be measured that are input to the optical spectrum analyzer 10, and generates the trigger signal to switch which light ray to be measured to input to the measurement unit 20. Due to the user program that outputs the trigger signal, the light ray to be measured can be switched in response to operations of the user program. This makes it easier to switch the input of the light ray to be measured to the measurement unit 20, in accordance with the changes of the light rays to be measured. As a result, the user's convenience is improved.

The optical switch 40 may be configured to accept input of a single trigger signal, and sequentially switch among multiple light rays to be measured when the trigger signal rises or falls. For example, when switching among an N number of light rays to be measured, from a first light ray to be measured to an Nth light ray to be measured, the optical switch 40 may switch from the first light ray to be measured to a second light ray to be measured in response to the input of the trigger signal, switch from the second light ray to be measured to a third light ray to be measured in response to the next input of the trigger signal, and switch from the Nth light ray to be measured to the first light ray to be measured.

The optical switch 40 may be configured to accept input of multiple trigger signals and switch to any of multiple light rays to be measured in response to input combining the multiple trigger signals. For example, when switching among a 2\hat{ }K−1 number of light rays to be measured, from a first light ray to be measured to a (2\hat{ }K−1)th light ray to be measured, the optical switch 40 may switch the light ray to be measured, in response to input of a K number of trigger signals. Specifically, the number of combinations of the K trigger signals is 2\hat{ }K−1. Therefore, the optical switch 40 may switch to any of the light rays to be measured, in response to a 2\hat{ }K−1 number of inputs corresponding to the combinations of the K trigger signals. This makes it possible for the optical switch 40 to immediately switch to any of the light rays to be measured even when the number of light rays to be measured, among which the optical switch 40 switches, increases.

<Configuration with Multiple Measurement Units 20>

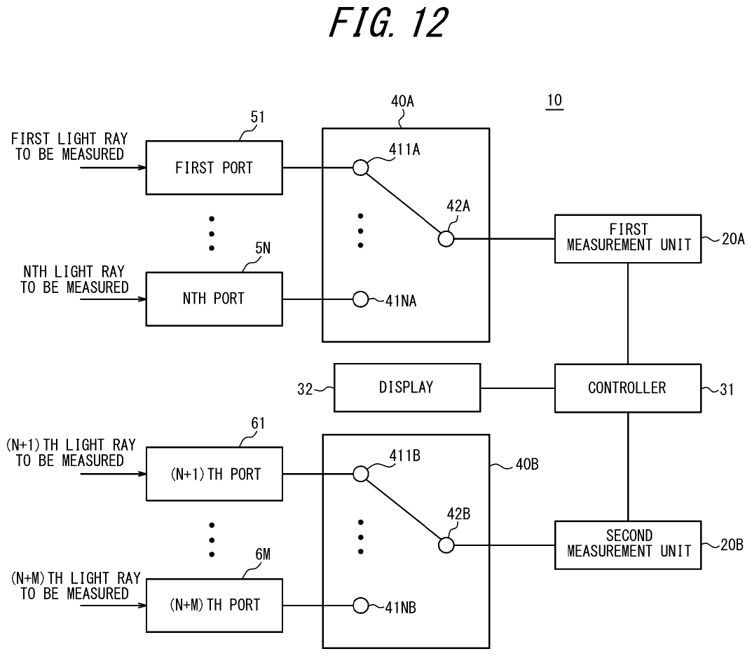

As illustrated in FIG. 12, the optical spectrum analyzer 10 may be provided with, as the measurement units 20, a first measurement unit 20A and a second measurement unit 20B. The first measurement unit 20A and the second measurement unit 20B may be configured in the same manner as the measurement unit 20.

The optical spectrum analyzer 10 may be further provided with a first optical switch 40A that switches to a light ray to be measured and inputs the light ray to be measured to the first measurement unit 20A. The first optical switch 40A is provided with terminals 411A to 41NA and a terminal 42A. The terminals 411A to 41NA are connected to first to Nth ports 51 to 5N, respectively. The terminal 42A is configured to be switchable to be connected to any of the terminals 411A to 41NA. The first optical switch 40A switches light input to the first measurement unit 20A to any of a first light ray to be measured, which is input to the first port 51, to an Nth light ray to be measured, which is input to the Nth port 5N.

The optical spectrum analyzer 10 may be further provided with a second optical switch 40B that switches to a light ray to be measured and inputs the light ray to be measured to the first measurement unit 20B. The second optical switch 40B is provided with terminals 411B to 41NB and a terminal 42B. The terminals 411B to 41NB are connected to (N+1)th to (N+M)th ports 61 to 6M, respectively. The terminal 42B is configured to be switchable to be connected to any of the terminals 411B to 41NB. The second optical switch 40B switches light input to the second measurement unit 20B to any of an (N+1)th light ray to be measured, which is input to the (N+1)th port 61, to an (N+M)th light ray to be measured, which is input to the (N+M)th port 6M.

The optical spectrum analyzer 10 is provided with the multiple measurement units 20, which allows parallel measurements of optical spectra of the multiple light rays to be measured. In addition, the optical spectrum analyzer 10 is provided with the multiple optical switches 40, which allows connection of an increased number of light rays to be measured.

### <Configuration in Which Optical Switch 40 Is Connected Externally>

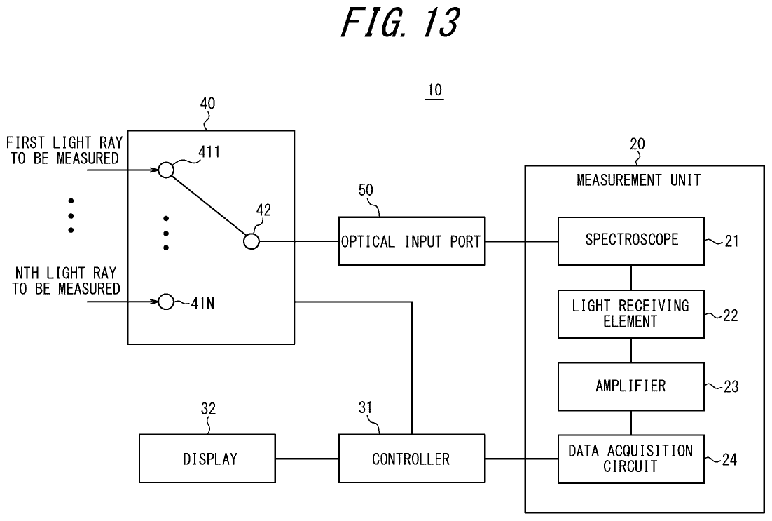

As illustrated in FIG. 13, the optical spectrum analyzer 10 may be provided with an optical input port 50 that can be connected to an optical switch 40 installed externally, without incorporating the optical switch 40. The controller 31 acquires, from the external optical switch 40, information specifying a light ray to be measured that is input to the optical input port 50. The controller 31 can measure an optical spectrum of each of the multiple light rays to be measured that are input from the optical switch 40 in a switchable manner, based on the information specifying the light ray to be measured that is input to the optical input port 50.

With this configuration in which the optical spectrum analyzer 10 can be connected to the external optical switch 40, without incorporating the optical switch 40, the optical spectrum measurement method according to the present disclosure is executed by the optical spectrum analyzer 10 that does not originally incorporate the optical switch 40. As a result, the user's convenience is improved.

The embodiments of the present disclosure have been described based on various drawings and examples, but it should be noted that a person skilled in the art would be able to make various modifications or changes based on the present disclosure. Therefore, note that these modifications or changes are included within the scope of the present disclosure. For example, the functions and the like contained in each component can be rearranged without contradicting logically, and it is possible to combine multiple components into one or divide a single component into multiple components.

1. A non-transitory computer readable medium storing an optical spectrum measurement program to measure, in a single sweep, optical spectra of multiple light rays to be measured, the optical spectrum measurement program configured to cause a processor to execute operations, the operations comprising:
acquiring a measurement result of intensity of a light ray to be measured that is selected one-by-one from among the multiple light rays to be measured; and
generating an optical spectrum of each light ray to be measured by associating the light ray to be measured that has been selected during measurement with the acquired measurement result.

2. The non-transitory computer readable medium according to claim 1, wherein the operations further comprise selecting the light ray to be measured from among the multiple light rays to be measured.

3. The non-transitory computer readable medium according to claim 2, wherein the operations further comprise, in a first period during which the light intensity at a first wavelength is measured in the sweep, acquiring a measurement result of the light intensity at the first wavelength for at least one light ray to be measured that is selected one-by-one from among the multiple light rays to be measured.

4. The non-transitory computer readable medium according to claim 3, wherein the operations further comprise, in the first period, acquiring measurement results of the light intensity at the first wavelength for all the multiple light rays to be measured.

5. The non-transitory computer readable medium according to claim 3, wherein the operations further comprise selecting light rays to be measured so that a number of light rays to be measured that are selected in a second period, during which the light intensity at a second wavelength is measured in the sweep, differs from a number of light rays to be measured that are selected in the first period.

6. The non-transitory computer readable medium according to claim 3, wherein the operations further comprise determining, based on accuracy required of measurement of each light ray to be measured, a number of light rays to be measured that are selected in each period during which the light intensity at each wavelength is measured in the sweep.

7. The non-transitory computer readable medium according to claim 1, wherein the operations further comprise acquiring a measurement result after an invalid period has elapsed since selecting a single light ray to be measured from among the multiple light rays to be measured and switching to the single light ray to be measured.

8. The non-transitory computer readable medium according to claim 1, wherein the operations further comprise, when multiple times of measurements of the light intensity at a measurement wavelength are performed, acquiring, as a measurement result of the light intensity at the measurement wavelength, a value calculated by statistical processing of multiple measurement values acquired in the respective multiple times of measurements.

9. An optical spectrum measurement method of generating, in a single sweep, optical spectra of multiple light rays to be measured, the optical spectrum measurement method comprising:
acquiring a measurement result of intensity of a light ray to be measured that is selected one-by-one from among the multiple light rays to be measured; and
generating an optical spectrum of each light ray to be measured by associating the light ray to be measured that has been selected during measurement with the acquired measurement result.

10. An optical spectrum analyzer configured to generate, in a single sweep, optical spectra of multiple light rays to be measured, the optical spectrum analyzer comprising:
at least one measurement unit configured to measure intensity of a light ray to be measured that is selected one-by-one from among the multiple light rays to be measured; and
a controller configured to generate an optical spectrum of each light ray to be measured, by associating the light ray to be measured that has been selected during measurement of the light intensity by the measurement unit with a measurement result of the light intensity by the measurement unit.

11. The optical spectrum analyzer according to claim 10, further comprising:
a switch configured to switch connection so as to input, to the measurement unit, a single light ray to be measured that is selected from the multiple light rays to be measured,
wherein the controller is configured to select, by controlling the switch, the single light ray to be measured that is input to the measurement unit, from among the multiple light rays to be measured.

12. The optical spectrum analyzer according to claim 11, wherein the switch is configured to accept input of a trigger signal and switch, in response to the input of the trigger signal, the light ray to be measured that is input to the measurement unit.

13. The optical spectrum analyzer according to claim 10, wherein when there are two or more measurement units, each of the two or more measurement units is configured to measure light intensity of a light ray to be measured that is selected one-by-one from among the multiple light rays to be measured.
